(19) United States
(12) Patent Application Publication
(10) Pub. No.: US 2007/0261263 A1
(43) Pub. Date: Nov. 15, 2007

(54) Drying Apparatus for Hydration Systems

(76) Inventor: Vincent Lee, Cerritos, CA (US)

Correspondence Address: QUICKPATENTS, INC., 32861 CALLE PERFECTO, SUITE A, SAN JUAN CAPISTRANO, CA, 92675, US

(21) Appl. No.: 11/382,911

(22) Filed: May 11, 2006

(51) Int. Cl. F26B 25/06; F26B 21/12

(52) U.S. Cl. 34/201; 34/241

(57) ABSTRACT

A drying apparatus for a personal hydration system is disclosed. The drying apparatus comprises an enclosure that includes a base portion and a neck portion. The base portion includes at least one air inlet opening and is adapted for contacting a support surface. The neck portion is in fluid communication with the base portion and includes an open distal end. An air blowing means is fixed within the base portion and moves air from outside of the enclosure, through the air inlet opening of the base portion, through the neck portion, and out of the open distal end thereof. An air heating means is further included fixed within the enclosure for heating the air in the enclosure. Preferably the air blowing means and the air heating means are electrically connected through a switch means and a controller circuit to a power source. The neck portion further includes at least one removable aperture adapter for temporary frictional engagement with both the open distal end of the neck portion and an aperture of the hydration system. As such, airflow may be directed into a hydration system reservoir when the hydration system is fixed to the aperture adapter of the drying apparatus. The controller circuit causes the air blowing means and the air heating means to cycle repeatedly to facilitate drying of the hydration system.

### CROSS-REFERENCE TO RELATED APPLICATIONS

Not applicable.

### STATEMENT REGARDING FEDERALLY SPONSORED RESEARCH AND DEVELOPMENT

Not applicable.

### FIELD OF THE INVENTION

This invention relates to drying apparatuses, and more particularly to a drying apparatus for a personal hydration system.

### DISCUSSION OF RELATED ART

Personal hydrations systems sold under the brand name CamelBack®, have become widely popular with sports and outdoor enthusiasts, as such devices are able to supply a person with potable water in a convenient manner. As with old-style canteens, however, such personal hydration systems also need to be cleaned occasionally and dried between uses. If water is allowed to sit in such a device between uses, which may be several weeks, the water within a reservoir of such a personal hydration system can become stagnant and unsuitable for drinking. Because the reservoirs of such systems collapse as water is drawn therefrom, and because the reservoirs are sealed at an aperture at one end thereof, air flow through such devices is minimized and, as such, they are difficult to thoroughly dry. Further, the drinking tubes of such devices are typically sealed at a distal end thereof and only opened when a user slightly bites down on a specially-formed mouthpiece.

Sock and ski boot driers are known in the art, such devices typically having a perforated conduit through which warmed air travels and is expelled. Wet articles are typically inverted and placed over the conduit, which allows warm air to circulate therethrough and dry the article. However, such devices are not well suited for use with personal hydration systems. Such driers are not adapted for forming any type of seal between the drier and the hydration system. Further, such driers make no provision for direct air to specific areas of the hydration system reservoir, and particularly towards the bottom or aperture end where water tends to collect when the hydration system is inverted over such a drier. Further, no provision is made to redistribute water around the reservoir to thin-out the water to facilitate drying, nor is there any provision for maintaining the drinking tube of such a hydration system in an open position while drying. As a result, such driers are ill-suited for use with hydrations systems.

U.S. Patent Application 2004/0244216 to Poole, published on Dec. 9, 2004, teaches a drying system made specifically for hydration systems. Such a device, however, shares many of the same drawbacks that conventional boot and sock driers have when used with CamelBak®-type hydration systems. For example, water tends to collect at the downward or aperture end of the reservoir when the reservoir is inverted and placed over a drying tube of such a device. No provision is made for drying the drinking tube, and no provision is made to cycle blowing and non-blowing cycles to further redistribute water within the reservoir for thinning-out same and facilitating drying. Such a device is bulky and awkward to use and store.

There is clearly a need, then, for a hydration system drier that does not suffer the drawbacks of the prior art devices. Such a need device would provide a compact, efficient means of thoroughly drying such a hydration system. The needed device would be useful on a number of different hydration systems having apertures of varying sizes, and would provide means for thoroughly drying the reservoir of such a device, as well as the drinking tube. Such a needed device would be extremely easy to use and would be relatively inexpensive to manufacture. The present invention accomplishes these objectives.

### SUMMARY OF THE INVENTION

The present device is a drying apparatus for a hydration system. The hydration system is of the type having a reservoir that includes an aperture at one end thereof, and a drinking tube having a mouthpiece at a distal end thereof.

The drying apparatus comprises a hollow, rigid enclosure that includes a base portion and a neck portion. The base portion includes at least one air inlet opening and is adapted for contacting a support surface, such as a table or counter top, for example. The neck portion is in fluid communication with the base portion and includes an open distal end.

An air blowing means is fixed within the base portion and moves air from outside of the enclosure, through the air inlet opening of the base portion, through the neck portion, and out of the open distal end thereof. An air heating means is further included fixed within the enclosure for heating the air as the air is blown through the enclosure. Preferably the air blowing means and the air heating means are electrically connected through a switch means and a controller circuit to a power source. Preferably the controller circuit causes the air blowing means and the air heating means to cycle repeatedly to facilitate drying of the hydration system.

The neck portion further includes at least one removable aperture adapter for temporary frictional engagement with the open distal end of the neck portion. The aperture adapter is adapted for temporary frictional engagement with the aperture of the hydration system. Further, the neck portion includes a nozzle piece that is adapted for temporary frictional engagement with the open distal end of the neck portion. The nozzle piece is open at one end and provides directional openings at the other end thereof. As such, airflow may be directed into selected areas of the hydration system reservoir when the hydration system is fixed to the drying apparatus.

In use, an appropriately-sized aperture adapter is selected so that the aperture of the hydration system may be fixed thereto. The selected aperture adapter is placed over the open distal end of the neck portion with the reservoir oriented towards and above the base portion of the enclosure. The drying apparatus is plugged into a wall outlet and the switch means is activated, causing the controller circuit to cyclically activate and deactivate the air blowing means and the air heating means to draw air into the enclosure through the at least one air inlet opening. Air then travels through the enclosure, is heated by the air heating means, and is forced out of the neck portion through the nozzle piece into selected areas of the reservoir of the hydration system. Air then travels up through the reservoir, through the drinking tube, and exits the mouthpiece.

The present invention provides a compact, efficient means of thoroughly drying a personal hydration system. The current device may be used on a number of different hydration systems having apertures of varying sizes, and provides means for thoroughly drying the reservoir of such a device as well as the drinking tube. The present invention is extremely easy to use and is relatively inexpensive to manufacture. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is an exploded perspective view if the invention, illustrating a drying apparatus of the present invention and a personal hydration system to be fixed to the drying apparatus;

FIG. 2 is a perspective illustration of the invention, illustrating the hydration system as attached to the drying apparatus and air flow through the drying apparatus and into the hydration system;

FIG. 3 is a bottom plan view of the invention;

FIG. 4 is a top plan view of the invention;

FIG. 5 is a rear elevational view of the invention;

FIG. 6 is a front elevational view of the invention;

FIG. 7 is an exploded cut-away view of the invention, illustrating a diagram of electrical components of the invention;

FIG. 8 is a cut-away view of the invention;

FIG. 9 is a cut-away view of the invention, illustrating the hydration system as attached thereto and the drying apparatus in an activated state; and

FIG. 10 is a schematic diagram of the electrical components of the invention.

### DETAILED DESCRIPTION OF THE PREFERRED EMBODIMENT

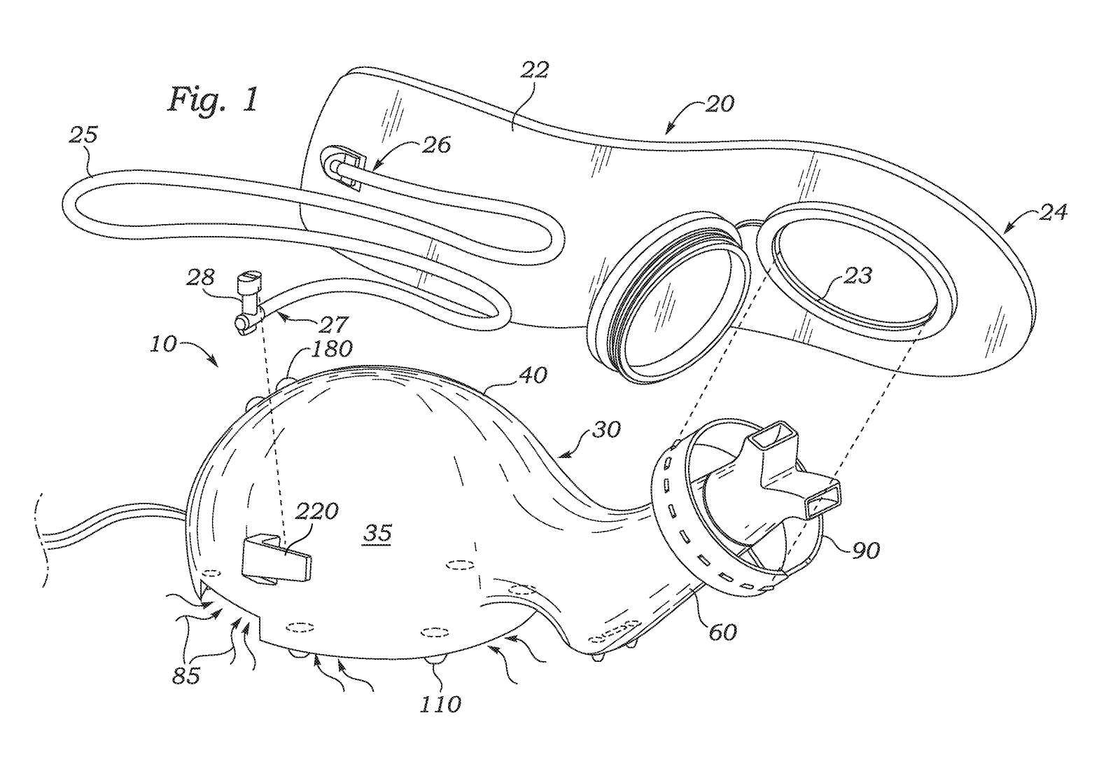

FIG. 1 illustrates a drying apparatus 10 for a hydration system 20. The hydration system 20, also referred to as a personal hydration system and sold under the brand name CamelBak®. The hydration system 20 is of the type having a reservoir 22 that includes an aperture 23 at one end 24 thereof, and a drinking tube 25. The drinking tube 25 is in fluid communication at a proximal end 26 thereof with the reservoir 22, and has a mouthpiece 28 at a distal end 27 thereof.

The drying apparatus 10 comprises a hollow, rigid enclosure 30 that includes a base portion 40 and a neck portion 60. The enclosure 30 is preferably made from a suitable injected-molded, rigid plastic material. The base portion 40 includes at least one air inlet opening 50 (FIG. 3) and is adapted for contacting a support surface 15 (FIGS. 5-8), such as a table or counter top, for example. The neck portion is in fluid communication with the base portion 40 and includes an open distal end 70.

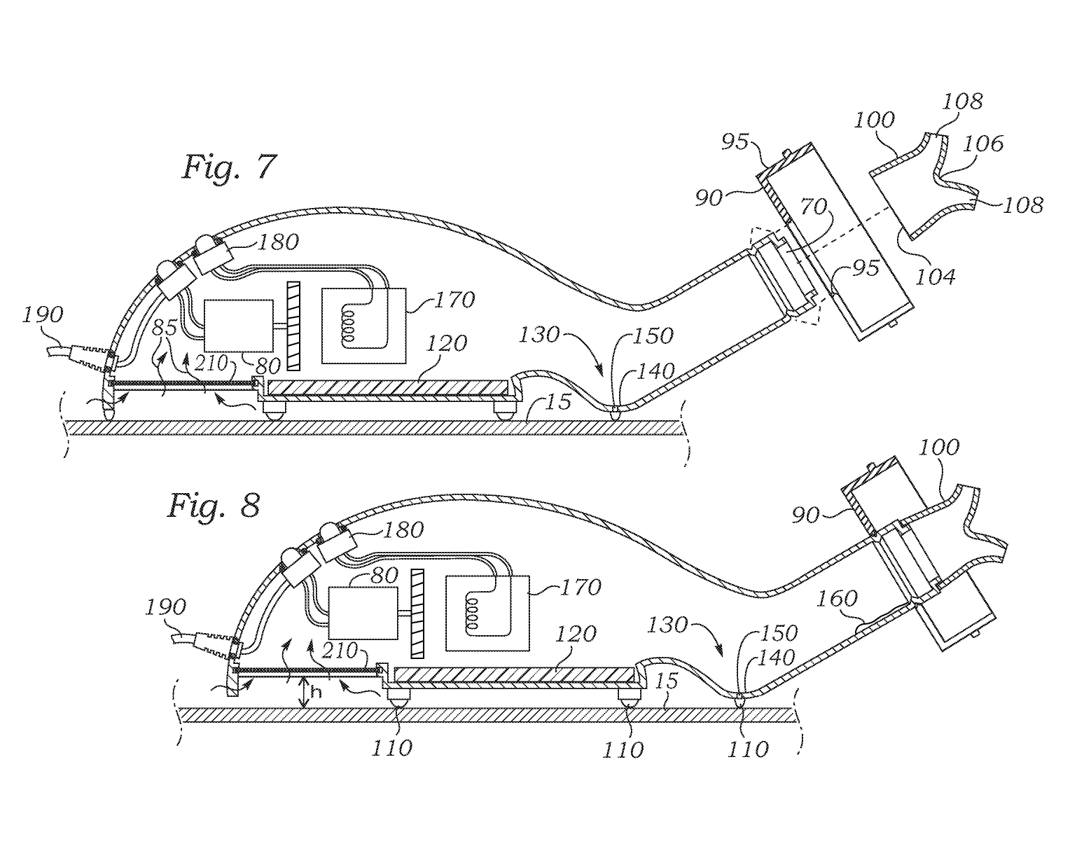

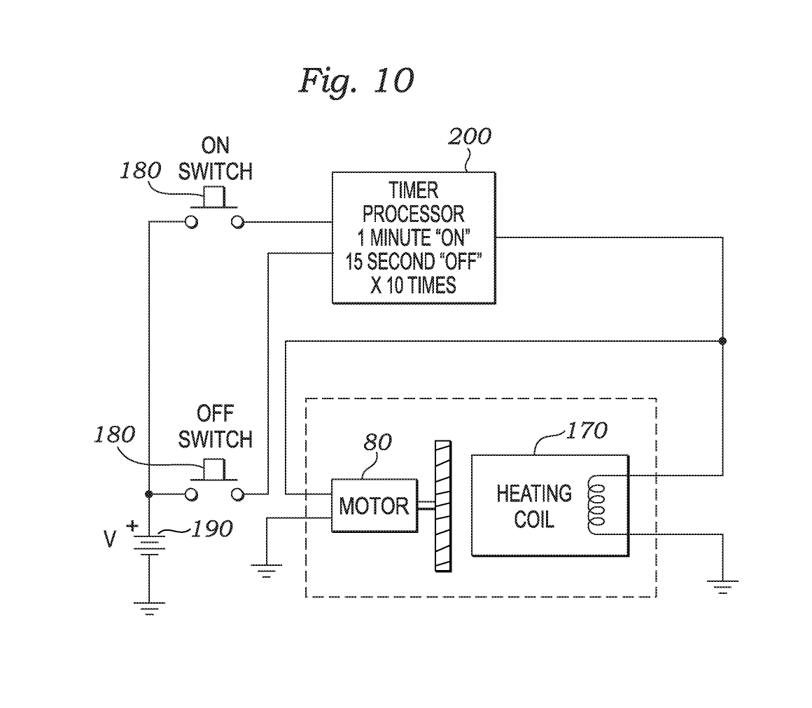

An air blowing means 80 is fixed within the base portion 40, by any suitable conventional means, and includes an electric fan, for example (FIGS. 7-10). The air blowing means 80 moves air 85 from outside of the enclosure 30, through the at least one air inlet opening 50 of the base portion 40, through the neck portion 60, and out of the open distal end 70 thereof. While those skilled in the art are able to fix such an air blowing means 80 within an enclosure 30 in any number of ways, preferably the air blowing means 80 effectively internally separates the at least one air inlet opening 50 from the neck portion 60. An air filter 210 is preferably included across the at least one air inlet opening 50 to filter at least a portion of the air 85 drawn through the at least one air inlet opening 50 (FIG. 7-9).

An air heating means 170, such as a resistive wire that heats surrounding air 85 when a current is passed therethrough, is further included fixed within the enclosure 30 for heating the air 85 as the air 85 is blown through the enclosure 30 and out of the open distal end 70 of the neck portion 60. Preferably the air blowing means 80 and the air heating means 170 are electrically connected through a switch means 180 to a power source 190, such as 110V AC, a battery, solar panels (not shown) or some other suitable power source. The switch means 180 preferably is manually actuable through the enclosure 30, such switch means 180 being mounted in a water resistant fashion so that water splashing onto the outside surface 35 of the enclosure 30 is not able to enter into the enclosure 30 or otherwise contact the electrical components of the invention.

The switch means 180 may be a manual switch for directly activating or deactivating the air blowing means 80 and the air heating means 170, or a manual switch for driving a controller circuit 200 that is capable of selectively activating and deactivating the air blowing means 80 and the air heating means 170 according to a program. Preferably the controller circuit 200 may cause the air blowing means 80 and the air heating means 170 to cycle repeatedly to facilitate drying of the hydration system 20. Such a repeating cycle may be one minute on, fifteen seconds off, for each of the air blowing means 80 and the air heating means 170, repeated ten times, for example. During the fifteen seconds of deactivation, such a cycle allows the hydration system 20 to de-inflate and collapse, causing the redistribution and thinning-out of any remaining water or other liquid 160 within the reservoir 22. It has been found that ten such one-minute fifteen-second cycles is typically sufficient to completely dry the hydration system 20. Clearly, however, other cycles could be programmed into the controller circuit 200 to effectively dry the hydration system 20. Such a controller circuit 200 would include a timing means (not shown) and other elements as necessary, which will be clear to those skilled in the art of such circuit design.

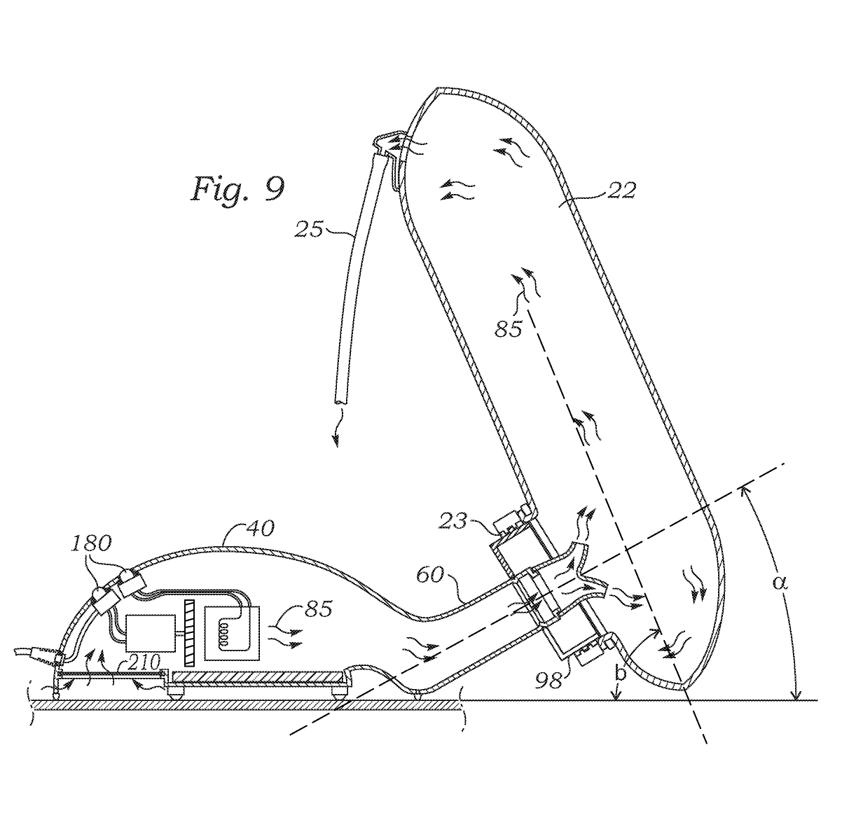

The neck portion 60 further includes at least one removable aperture adapter 90, each of which include a neck aperture 95 for temporary frictional engagement with the open distal end 70 of the neck portion 60. The aperture adapter 90 has an outer circumference 98 adapted for temporary frictional engagement with the aperture 23 of the hydration system 20. Such an adapter 90 is preferably made from the same rigid plastic material as the enclosure 30, and includes a gap along one radius thereof to allow the adapter 90 to flex slightly to accommodate placement thereof over the distal end 70 of the neck portion 60. As such, one of a plurality of adapters 90 of varying sizes may be selected for frictional engagement with one of a plurality of hydration systems 20 having apertures 23 of corresponding varying sizes. Further, the neck portion 60 includes a nozzle piece 100 that is adapted for temporary frictional engagement with the open distal end 70 of the neck portion 60 (FIGS. 7 and 8). The nozzle piece 100 is open at one end 104 and provides directional openings 108 at the other end 106 thereof. As such, airflow may be directed into selected areas of the hydration system reservoir 22 when the hydration system 20 is fixed to the drying apparatus 10 (FIG. 9).

A mouthpiece retaining clip 220 may be included, preferably on the outside surface 35 of the enclosure 30, that when engaged to the mouthpiece 28 of the hydration system 20 retains the mouthpiece 28 in an open position, such that air traversing through the aperture 23 of the hydration system, into the reservoir 22, and through the drinking tube 25 may exit the mouthpiece 28 with less resistance that if the mouthpiece 28 were not held open. As such, more air 85 may flow completely through the hydration system 20 to more thoroughly dry the hydration system 20.

A trough 130 is advantageously included in the next portion 60 at a low point 140 thereof (FIGS. 3 and 8). The trough 130 has at least one liquid drain opening 150, such that any liquid 160 transferred from the hydration system 20 into the neck portion 60 flows into the trough 130 and out of the enclosure 30 through the at least one drain opening 150.

A plurality of high-friction foot pads 110, such as rubber foot pads, are included on the base portion 40 and the neck portion 60 (FIGS. 1 and 3). The foot pads 100 resist lateral movement of the apparatus 10 along the support surface 15 and maintain the at least one air inlet opening 50 a predefined height h above the support surface 15 (FIG. 8). A weight means 120, such as an ingot of metal or other high-density material, is further included in the base portion 40 to further inhibit movement of the drying apparatus 10 on the support surface 15, particularly when the support surface 15 is a horizontal table or counter top, or other horizontal support surface.

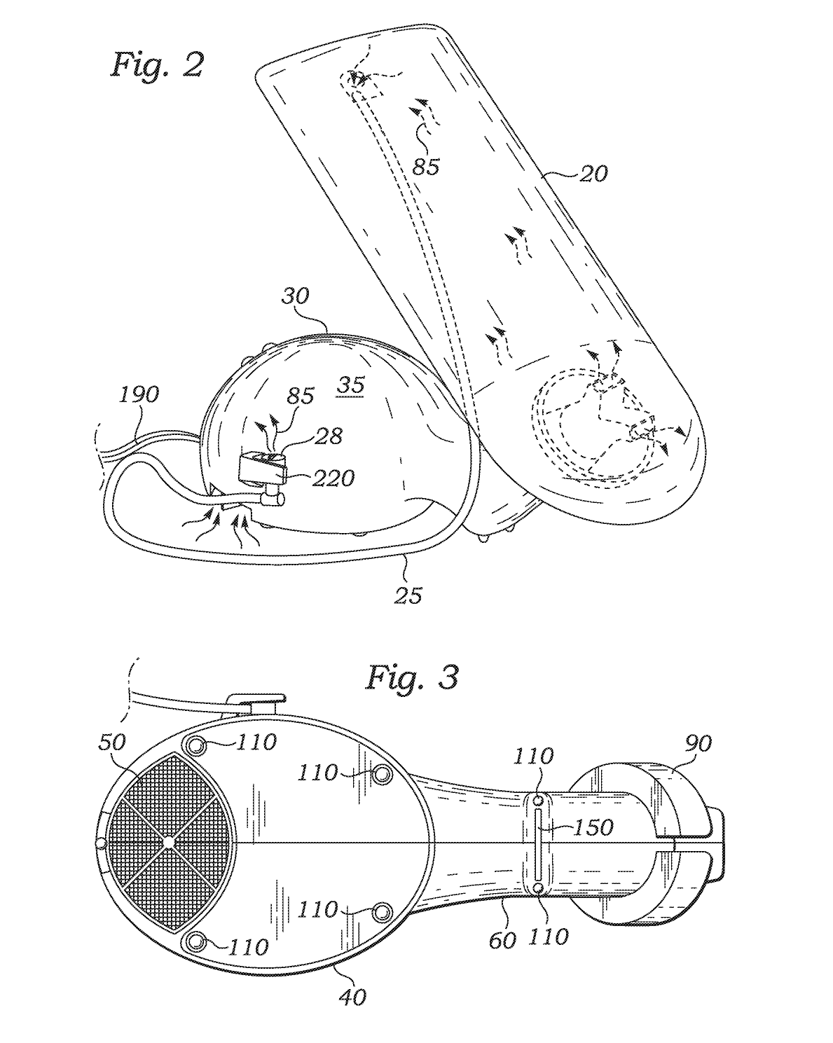

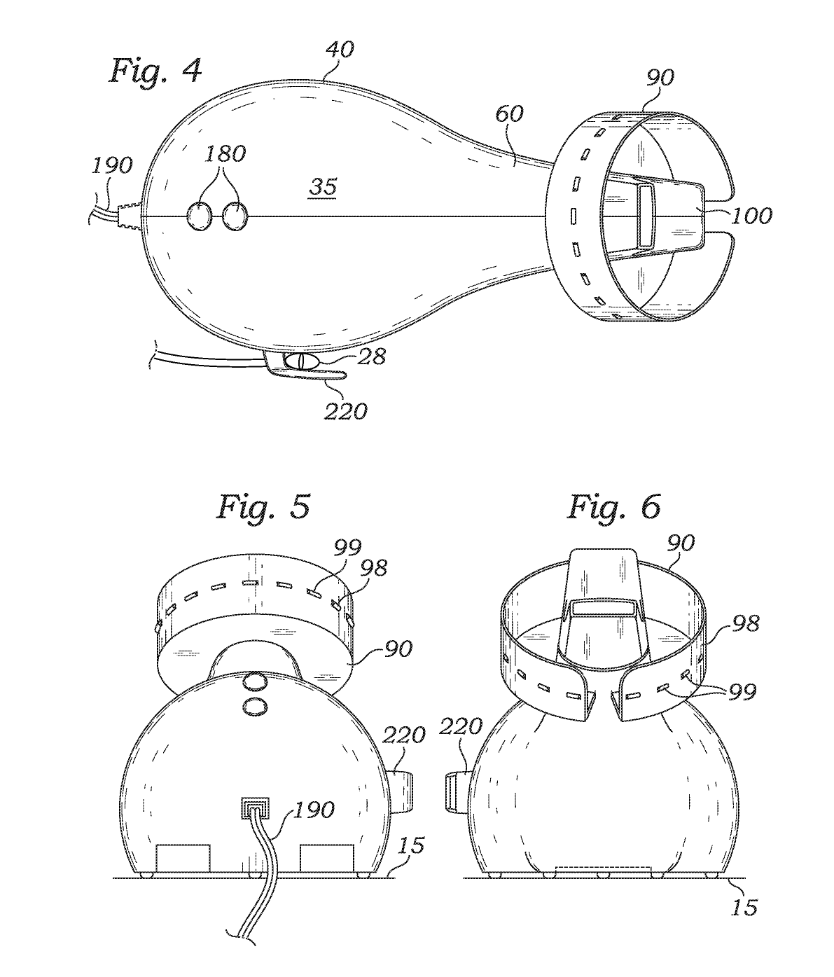

In use, an appropriately-sized aperture adapter 90 is selected so that the aperture 23 of the hydration system 20 may be fixed thereto (FIGS. 7 and 8). The selected aperture adapter 90 is placed over the open distal end 70 of the neck portion 60 with the reservoir 22 oriented towards and above the base portion 40 of the enclosure 30. The mouthpiece 28 is engaged to the mouthpiece retaining clip 220 (FIGS. 2-4) such that the mouthpiece 28 assumes an open state, as illustrated in FIG. 2. The drying apparatus 10 is plugged into a wall outlet (not shown) or otherwise connected to an appropriate power source 190. The switch means 180 is activated, and in the preferred embodiment, the controller circuit 200 then activates the air blowing means 80 and the air heating means 170 to draw air 85 into the enclosure 30 through the at least one air inlet opening 50 and air filter 210.

Air 85 then travels through the enclosure 30, is heated by the air heating means 170, and is forced out of the neck portion 60 through the nozzle piece 100 into selected areas of the reservoir 22 of the hydration system. Air 85 then travels up through the reservoir 22, through the drinking tube 25, and exits the mouthpiece 28. When activated, the air blowing means 80 causes the hydration system to become inflated. With the neck portion 60 forming an angle a of between twenty and sixty degrees, and preferably approximately 40 degrees, with respect to the support surface 15 (FIG. 9). As such, the hydration system 20, and specifically the inflated reservoir 22, is caused to assume an angle β with respect to the support surface 15. Such an angle β, which is roughly 180-α, but somewhat depends upon the specific construction of the reservoir 22, has been found to optimally draw liquid 160 down towards the one end 24 of the reservoir 22. As such, the nozzle piece 100 can be oriented to concentrate a large portion of the airflow into this one end 24 of the reservoir 22 to cause rapid drying of the liquid 160 therein.

While a particular form of the invention has been illustrated and described, it will be apparent that various modifications can be made without departing from the spirit and scope of the invention. For example, the exact placement of the sound emitting means 20 may vary within the pocket formed by folding the secondary page 70. The tape 90 may alternately be a dab of glue. Accordingly, it is not intended that the invention be limited, except as by the appended claims.

What is claimed is:

1. A drying apparatus for a hydration system of the type having a reservoir that includes an aperture at one end thereof and a drinking tube, the drinking tube in fluid communication at a proximal end thereof with the reservoir, the drinking tube having a mouthpiece at a distal end thereof, the drying apparatus comprising:
a substantially hollow, rigid enclosure, the enclosure comprising a base portion having at least one air inlet opening and adapted for contacting a support surface, a neck portion open at a distal end thereof and adapted for temporary frictional engagement with the aperture of the hydration system; and
an air blowing means for moving air from outside of the enclosure, through the at least one air inlet opening of the base portion, through the neck portion and out of the open distal end.

2. The drying apparatus of claim 1 wherein the neck portion further includes a removable aperture adapter having a neck aperture, the neck aperture for temporary frictional engagement with the open distal end of the neck portion, the aperture adapter having an outer circumference adapted for temporary frictional engagement with the aperture of the hydration system, whereby one of a plurality of adapters of varying sizes may be selected for frictional engagement with one of a plurality of hydration systems having apertures of corresponding varying sizes.

3. The drying apparatus of claim 1 wherein the neck portion further includes a nozzle piece adapted for temporary frictional engagement with the open distal end of the neck portion, the nozzle piece open at one end and providing directional openings at the other end, whereby airflow may be directed into selected areas of the hydration system reservoir when the hydration system is fixed to the drying apparatus.

4. The drying apparatus of claim 1 wherein the base section includes a plurality of high-friction foot pads for resisting movement of the apparatus along the support surface and maintaining the at least one air inlet opening a predefined height above the support surface.

5. The drying apparatus of claim 1 wherein the base section includes a weight means for further inhibiting movement of the drying apparatus on the support surface, the support surface being generally horizontal.

6. The drying apparatus of claim 1 wherein the neck portion further includes a trough at a low point thereof, the trough having liquid drain openings, whereby any liquid transferred from the personal hydration system into the neck portion flows into the trough and out of the enclosure through the drain openings.

7. The drying apparatus of claim 1 wherein the air blowing means further includes an air heating means for heating the air as the air is blown through the enclosure.

8. The drying apparatus of claim 7 wherein the heating means and the air blowing means are each electrically connected through a switch means to a power source.

9. The drying apparatus of claim 8 further including a controller circuit, the controller circuit capable of selectively activating and deactivating the air blowing means and the heating means independently so as to cause the air blowing means and the heating means to cycle repeatedly to facilitate drying of the hydration system.

10. The drying apparatus of claim 1 wherein the base section further includes an air filter for filtering air drawn into the air inlet openings.

11. The drying apparatus of claim 1 wherein the neck portion is disposed at an angle of between twenty and sixty degrees with respect to the support surface when the drying apparatus is supported by the support surface.

12. The drying apparatus of claim 1 wherein the neck portion is disposed at an angle of about forty degrees with respect to the support surface when the drying apparatus is supported by the support surface.

13. The drying apparatus of claim 1 wherein the enclosure further includes a mouthpiece retaining clip on an outside surface thereof, the mouthpiece retaining clip adapted to frictionally retain the mouthpiece of the hydration system in an open position such that air entering the reservoir of the hydration system may flow through the reservoir, through the drinking tube, and out of the open mouthpiece, to facilitate drying of the drinking tube and mouthpiece.
